(19) United States
(12) Patent Application Publication
(10) Pub. No.: US 2012/0268964 A1
(43) Pub. Date: Oct. 25, 2012

(54) DIFFUSER FILM WITH CONTROLLED LIGHT COLLIMATION

(75) Inventors: Adel F. Bastawros, Newburgh, IN (US); Zhe Chen, Shanghai (CN); Wibowo Harsono, Shanghai (CN); Jian Zhou, Evansville, IN (US)

(73) Assignee: SABIC INNOVATIVE PLASTICS IP B.V., Bergen op Zoom (NL)

(21) Appl. No.: 13/090,826

(22) Filed: Apr. 20, 2011

(51) Int. Cl. F21V 7/22; G02B 5/02

(52) U.S. Cl. 362/606; 359/599

(57) ABSTRACT

In one embodiment, a diffuser film with controlled light collimation comprises: a plastic layer having a first side and a second side, the first side having a first textured surface, wherein 20 to 50 percent of slope angles on the first textured surface proximate a first axis have a value of zero to five degrees. In one embodiment, a back lighted device, comprises: a light source, a light guide disposed proximate the light source for receiving light from the light source, and the diffuser film. In one embodiment, a method of controlling collimation in a diffusing film, comprises: determining a desired degree of collimation of the diffusing film; and texturing a plastic layer to form a first textured surface, wherein 20 to 50 percent of slope angles on the first textured surface proximate a first axis have a value of zero to five degrees.

### BACKGROUND

A conventional liquid crystal display (LCD) backlight unit employs one or multiple lamps (fluorescent type or LED type) at discrete locations in the backlight unit and a light management film stack above the lamp(s) that diffuses and redirects the light from the lamps in order to provide uniform and sufficient brightness over the entire display area for the LCD panel. A conventional light management film stack typically comprises at least one brightness enhancement film such as prismatic films and at least one diffuser film below or above the brightness enhancement film(s). The brightness enhancement film can reshape the angular distribution of the light transmitting through the film more toward the target direction of the display (typically, the normal axis of the display), therefore increasing the brightness along that target direction. Brightness enhancement films, by themselves, are not effective in creating uniform light distributions, and the location and pattern of the light source can be visible through the film. Diffuser films are therefore added to the film stack to “spread-out” or diffuse the light from the localized light sources so as to eliminate the visibility of a light pattern or non-uniformities in the brightness profile across the surface of the backlight unit. The capability of the diffuser film to “spread-out” the light laterally across the display surface is referred to as “hiding power” that is directly correlated to the haze of the diffuser film. A diffuser film with a high haze is especially desirable when the lamps are compact and very bright such as LED lamps, which are difficult to hide.

The functionalities of the brightness enhancement film and the diffuser film in back light modules are often conflicting; the former concentrates and redirects light while the latter diffuses and spreads light. The optical designer is forced to penalize one or both of these functionalities to reach a working film stack. Clearly, there is a need for diffuser film which in addition to having full functionality as a diffuser film spreading light evenly across the display area and achieving necessary hiding power, retains a controlled degree of light turning or collimation. Such diffuser film with controlled light collimation maximizes both brightness and hiding power of the film stack. The need for the diffuser film with controlled light collimation is found in a number of film stack configurations, including the following two backlight applications: 1) bottom diffuser film used below two prismatic films whose individual prism orientations are crossed to each other (e.g., in small portable LCD devices); and 2) top diffuser film used above a single prismatic film.

### BRIEF DESCRIPTION

Disclosed herein are diffuser films, back light modules, and methods for making and using the same.

In one embodiment, a diffuser film with controlled light collimation comprises: a plastic layer having a first and a second side opposite the first side and a first peripheral edge, the first side having a first textured surface, wherein 20 to 50 percent of slope angles on the first textured surface proximate a first axis have a value of zero to five degrees.

In one embodiment, a back lighted device, comprises: a light source, a light guide disposed proximate the light source for receiving light from the light source, and the diffuser film.

In one embodiment, a method of controlling collimation in a diffusing film, comprises: determining a desired degree of collimation of the diffusing film; forming a plastic layer having a first side and a second side opposite the first side and a first peripheral edge, and texturing the first side to form a first textured surface, wherein 20 to 50 percent of slope angles on the first textured surface proximate a first axis have a value of zero to five degrees.

Other systems and/or methods according to the embodiments will become or are apparent to one with skill in the art upon review of the following drawings and detailed description. It is intended that all such additional systems and methods be within the scope hereof, and be protected by the accompanying claims.

### BRIEF DESCRIPTION OF THE DRAWINGS

Refer now to the drawings, which are meant to be exemplary, not limiting, and wherein like elements are number alike.

FIG. 1 is a schematic of high light collimation.

FIG. 2 is a schematic of controlled light collimation.

FIG. 3 is a schematic diffuse or no light collimation.

FIG. 4 is an exploded view of an exemplary direct-lit back lighted device.

FIG. 5 is a schematic of a portion of the back lighted device of FIG. 4.

FIG. 6 is an exploded view of an exemplary an edge-lit back lighted device.

FIG. 7 is a schematic of a portion of the back lighted device of FIG. 6.

FIG. 8 is a cross-sectional schematic of an exemplary diffuser film with controlled light collimation utilized in the back lighted devices of FIGS. 4 and 6.

FIG. 9 is a graph indicating a slope distribution on a front surface of example A of the diffuser film with controlled light collimation.

FIG. 10 is a graph indicating a slope distribution on a front surface of example B of the diffuser film with controlled light collimation.

FIG. 11 is a graph indicating a slope distribution on a front surface of example C of a diffuser film without controlled light collimation.

FIG. 12 is a graph indicating a slope distribution on a front surface of example D of a diffuser film without controlled light collimation.

FIG. 13 is a top view of a cylindrical roller illustrating exemplary trajectories for determining a slope angle distribution.

FIG. 14 is a top view of a diffuser film with controlled light collimation illustrating exemplary trajectories for determining a slope angle distribution.

FIG. 15 is a top view of a cylindrical roller illustrating exemplary trajectories for determining a slope angle distribution.

FIG. 16 is a top view of a diffuser film with controlled light collimation illustrating exemplary trajectories for determining a slope angle distribution.

FIG. 17 is a schematic of a melt calendaring system for manufacturing a diffuser film with controlled light collimation.

FIG. 18 is a schematic of an embossing system for manufacturing a diffuser film with controlled light collimation.

FIG. 19 is a schematic of an energy beam engraving system for obtaining a textured surface on a cylindrical roller.

FIG. 20 is a schematic of a textured surface on a cylindrical roller obtained using the energy beam engraving system of FIG. 19.

FIG. 21 is a schematic of a textured surface on a diffuser film with controlled light collimation obtained using the cylindrical roller of FIG. 20.

FIG. 22 is a schematic of a metal ion deposition system for obtaining a textured surface on a cylindrical roller.

FIG. 23 is a schematic of chemical etching engraving system for obtaining a textured surface on a cylindrical roller.

FIG. 24 is an enlarged cross-sectional view of a portion of the cylindrical roller utilized by the system of FIG. 23.

### DETAILED DESCRIPTION

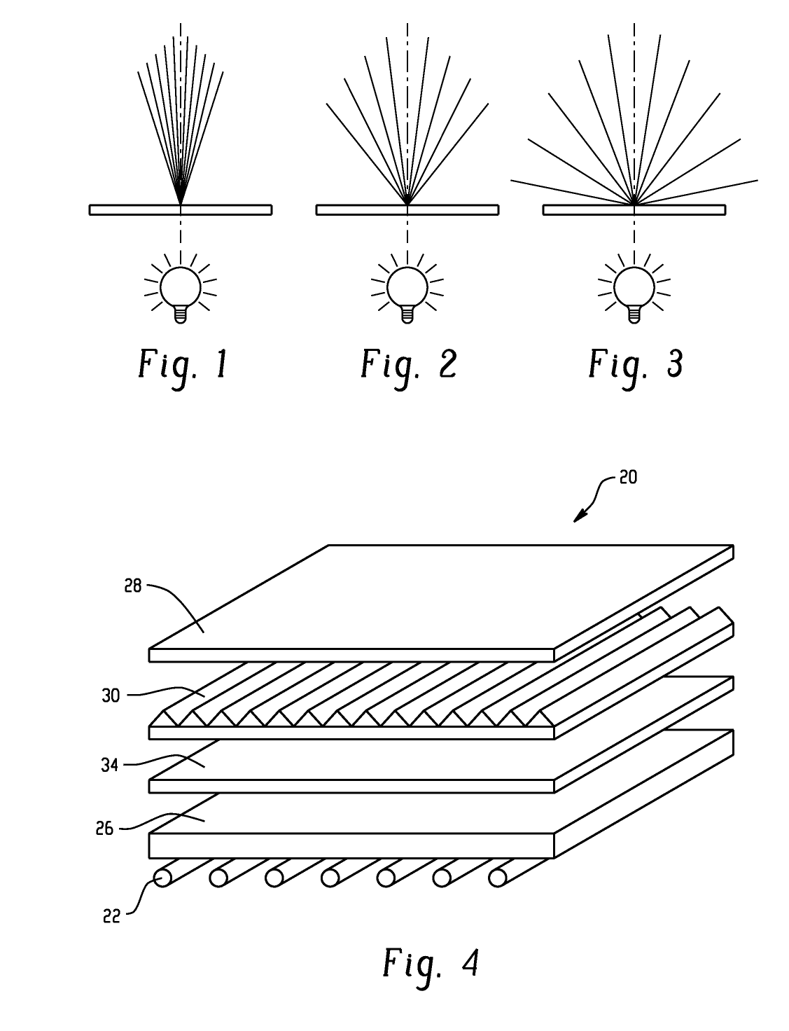

Herein, light collimation refers to film's ability to concentrate and redirect light toward a desired or target direction. A film with high light collimation is one that maximizes the concentrating and redirecting of light toward the target direction (see FIG. 1). A film with controlled light collimation is one where the level of light concentrating and redirecting is controlled (see FIG. 2), e.g., is chosen based upon the desired application of the film and the film is formed to have the chosen level.

The diffuser film disclosed herein is capable of providing both high haze (of 80% or greater) and the control light collimation effect that allows the desired brightness profile for the backlight applications. Manufacture of a diffuser film with controlled light collimation comprises determining the desired light collimation capabilities for a given application, determining the slope angles that attain the desired light collimation, and texturing a plastic film to have the desired slope angles. Generally, a certain percent of the texturing will have specific slope angles in order to attain the desired collimation.

The texturing can be attained using various methods such as calendaring, embossing, and others, as well as combinations comprising at least one of the foregoing. Some techniques, systems, and tools for texturing are disclosed, for example, in U.S. Pat. No. 7,889,427 to Bastawros et al.

For example, a method for manufacturing a diffuser film with controlled light collimation can include extruding heated plastic through a die to form a plastic layer. The plastic layer has a first side and a second side. The plastic layer extends along both a first axis (e.g., first axis for film 28 is arrow A1 in FIG. 6) and a second axis (e.g., second axis for film 28 is arrow A2 in FIG. 6) substantially perpendicular to the first axis. The method further includes cooling at least one of first and second rotating cylindrical rollers below a predetermined temperature. The method further includes moving the plastic layer between first and second rotating cylindrical rollers, the first cylindrical roller contacting the first side of the plastic layer and the second cylindrical roller contacting the second side. The first cylindrical roller forms a first textured surface on the first side of the plastic layer, wherein 20 to 50 percent of slope angles on the first textured surface approximately along the first axis have a value of zero to five degrees.

The system includes an extruder device operably coupled to a die. The extruder device urges heated plastic through the die to form a plastic layer. The plastic layer has a first side and a second side. The plastic layer extends along both a first axis and a second axis substantially perpendicular to the first axis. The system further includes first and second cylindrical rollers disposed proximate one another for receiving the plastic layer. The system further includes a cooling device configured to cool the first and/or second cylindrical rollers below a predetermined temperature.

In another embodiment the method includes heating a plastic layer having a first side and a second side and extending along both a first axis and a second axis substantially perpendicular to the first axis. The method further includes heating at least one of the first and second cylindrical rollers above a predetermined temperature. The method further includes moving the plastic layer between first and second rotating cylindrical rollers wherein the first cylindrical roller contacts the first side of the plastic layer and the second cylindrical roller contacts the second side. The first cylindrical roller forms a first textured surface on the first side proximate the first axis of the plastic layer, wherein between 20 to 50 percent of slope angles on the first textured surface proximate the first axis have a value between zero and five degrees.

A system for forming the film can include heating device(s) configured to heat a plastic layer, cylindrical rollers disposed proximate one another for receiving the plastic layer, and heating device(s) configured to heat first and/or second cylindrical rollers. One or both of the cylindrical rollers can comprise an external textured surface having a plurality of projecting portions and a plurality of trough portions, wherein each projecting portion extends outwardly from at least one adjacent trough portion. The plurality of projecting portions and the plurality of trough portions define a plurality of slope angles.

The external textured surface can be formed in various manners, including the use of pulsed energy, metal-ion deposition, etching in combination with a chemically resistant coating, and the like. For example, a pulsating energy beam can be emitted such that it contacts the outer surface of the cylindrical roller at a predetermined intensity. Relative motion can be created between the beam and the roller, (e.g., by moving the energy beam from the first end to the second end of the cylindrical roller during the rotation of the cylindrical roller), wherein the energy beam removes portions of the outer surface to obtain the desired textured surface. In an alternative example, the use of an electrolyte fluid can comprise rotating the cylindrical roller at a predetermined rotational speed about the first axis in an electrolyte fluid wherein the cylindrical roller is electrically grounded. A predetermined current density can be applied to the electrolyte fluid wherein metal ions in the fluid bond to the outer surface of the cylindrical roller to form the desired textured surface. In another alternative example, when a chemically resistant coating is employed, the method can include coating the cylindrical roller with the chemically resistant layer, wherein the chemically resistant layer is removed at predetermined locations to expose the underlying cylindrical roller surface at those locations. The cylindrical roller can be rotated at a predetermined rotational speed about the first axis in a container containing an etching solution that removes portions of the cylindrical roller at the predetermined locations to obtain the desired textured surface.

A back lighted device in accordance with another exemplary embodiment is provided. The back lighted device includes a light source and optionally a light guide disposed in optical communication with the light source when the light source emits light. The diffuser film with the desired textured surface can be disposed on a viewer side of the light source (e.g., between the light source (or the light guide if used) and a potential viewer).

The diffuser film can optionally be a single, unitary film comprising the controlled light collimation. In some embodiments, greater than or equal to 80 percent of a total mass of the unitary layer comprises a polycarbonate compound. The first side (e.g., the viewer side) of the unitary film can have a first textured surface, wherein between 20 to 50 percent of slope angles on the first textured surface proximate the first axis have a value between zero and five degrees. The diffuser film can controls collimation of light propagating therethrough.

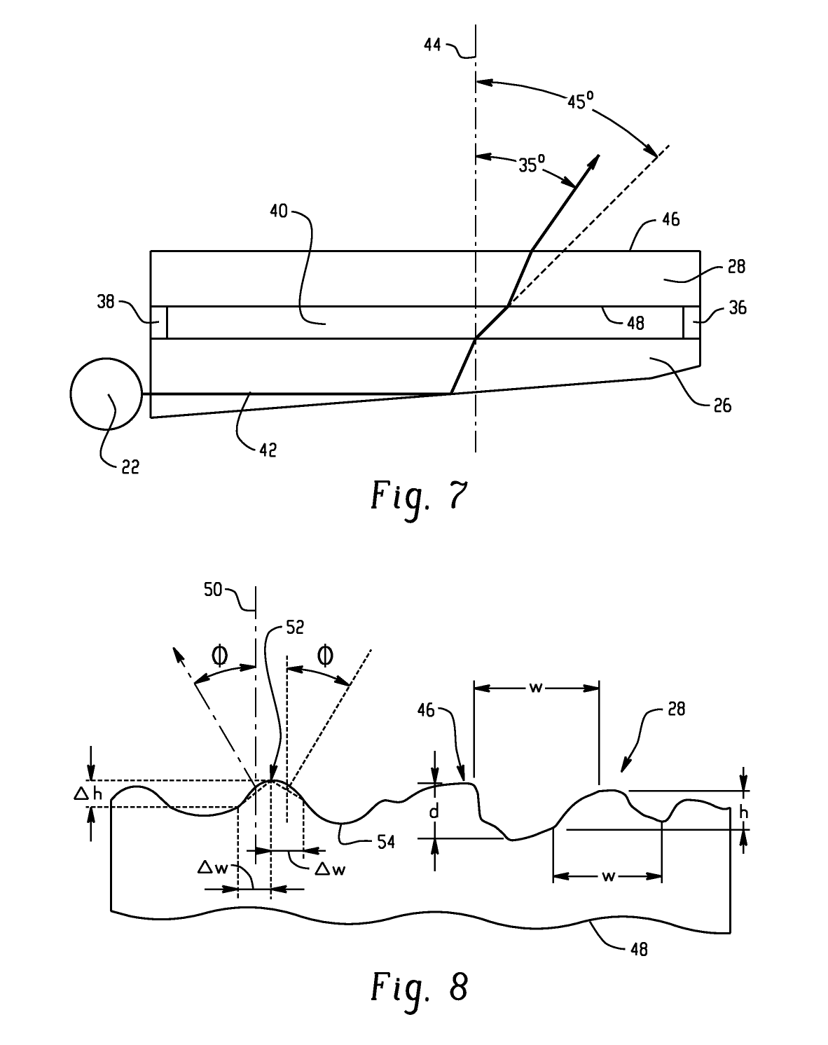

Referring to FIGS. 6 and 7, a back lighted device 20 for illuminating a liquid crystal display device (not shown) is illustrated. The back lighted device 20 includes a light source 22, a reflector film 24, a light guide 26, a diffuser film with controlled light collimation 28, a brightness enhancement film 30, a brightness enhancement film 32, and a light diffuser film 34. As shown, the light source 22 is disposed at a first end of the light guide 26. Further, the reflector film 24 is disposed, proximate a second side of the light guide 26. A second side of the diffuser film with controlled light collimation 28 is disposed proximate a first side of the light guide 26 and is spaced apart from the light guide 26 utilizing posts 36, 38. The posts 36, 38 form an air gap 40 between the light guide 26 and the film 28. The light collimating film 30 is disposed proximate a first side of the film 28. Finally, the light collimating film 32 is disposed proximate the light collimating film 30 and the light diffusing film 34 is disposed proximate the light collimating film 32.

Referring to FIG. 7, the path of an exemplary light beam propagating through both the light guide 26 and the diffuser film with controlled light collimation 28 will now be explained. The light source 22 emits a light beam 42 that propagates through the light guide 26 and is refracted therein toward an axis 44 that is substantially perpendicular to a top surface of the light guide 26. When the light beam 42 exits the light guide 26 and the air gap 40, the light beam 42 is refracted away from the axis 44 (e.g., at approximately 45°). When the light beam 42 enters the diffuser film 28 with controlled light collimation, the film 28 refracts the light beam 42 toward the axis 44. Thereafter, when the light beam 42 exits the film 28 the light beam is refracted toward the axis 44 (e.g., at approximately 35°). Thus, the film 28 collimates or redirects the light beam 42 closer toward the axis 44 (e.g., by about 10°). Of course, it should be understood that film 28 could redirect the light beam greater than or less than 10° toward the axis 44.

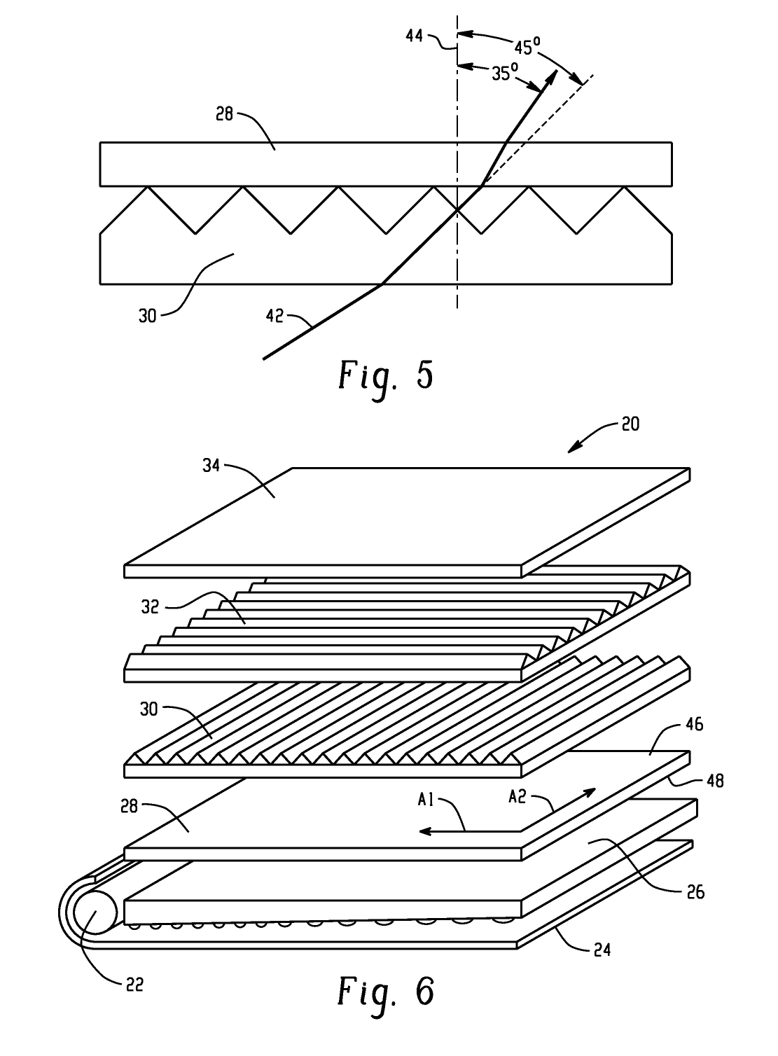

Referring to FIGS. 4 and 5, another example of a direct-lit back lighted device for illuminating a liquid crystal display device (not shown) is illustrated. In this configuration the light source 22 comprises a series of lamps placed directly underneath light guide or diffuser plate 26. The back lighted device 20 includes a light source 22, a light guide or diffuser plate 26, a diffuser film 34, a brightness enhancement film 30, and a diffuser film with controlled light collimation 28. The path of an exemplary light beam 42 propagating through both the brightness enhancement film 30 and the diffuser film with controlled light collimation 28 is shown in FIG. 5. Similar to the path of FIG. 7, when light beam 42 enters the diffuser film 28 with controlled light collimation, the film 28 refracts the light beam 42 toward the axis 44. Thereafter, when the light beam 42 exits the film 28 the light beam is refracted toward the axis 44 (e.g., at approximately 35°). Thus, the film 28 collimates or redirects the light beam 42 closer toward the axis 44 (e.g., by about 10°). Of course, it should be understood that film 28 could redirect the light beam greater than or less than 10° toward the axis 44.

Referring to FIGS. 5, 7, and 8, the diffuser film with controlled light collimation 28 will now be explained in greater detail. The film 28 is utilized to refract light beams toward the axis 44. The film 28 is constructed from a plastic layer having a thickness of up to and exceeding 10 millimeters (mm), specifically, 0.025 to 10 millimeters. Of course the film 28 can be constructed from a single layer of a single material or multiple layers of the same or different materials coextruded or co-laminated together during the calendering or embossing processes used to make the final film.

The film 28 can have an optical brightener compound disposed in the plastic layer wherein a mass of the optical brightener compound can be 0.001 to 1.0 percent of a total mass of the plastic layer. The film 28 can also, or alternatively, include an ultraviolet (UV) absorber compound, e.g., distributed in the plastic layer. The mass of the UV absorber compound can be 0.01 to 1.0 percent of a total mass of the plastic layer. The film 28 additionally, or alternatively, comprises an antistatic compound, such as fluorinated phosphonium sulfonate, disposed in the plastic layer. Fluorinated phosphonium sulfonate has a general formula:

{CF₃(CF₂)ₙ(SO₃)}^{θ}{P(R₁)(R₂)(R₃)(R₄)}^{Φ}

wherein F is fluorine; n is an integer from 1 to 12, S is sulfur; R₁, R₂ and R₃ are the same element, each having an aliphatic hydrocarbon radical of 1 to 8 carbon atoms or an aromatic hydrocarbon radical of 6 to 12 carbon atoms; and R₄ is a hydrocarbon radical of 1 to 18 carbon atoms.

The film 28 includes a textured top surface 46 having a plurality of projecting portions 52 and a plurality of trough portions 54. An average height (“h”) of the plurality of projecting portions 52 can be 5 to 25 percent of an average width (“w”) of the plurality of projecting portions. Further, the average width of the plurality of projecting portions 52 can be up to 100 micrometers, specifically 0.5 to 100 micrometers (μm). The projecting portions 52 and the trough portions 54 are distributed on the top surface 46 to obtain a desired slope angle distribution. An average depth (“d”) of the plurality of trough portions 54 can be 5 to 25 percent of an average width (“w”) of the plurality of trough portions. Further, the average width of the plurality of trough portions 54 can be up to 100 micrometers, specifically 0.5 to 100 micrometers (μm). The projecting portions 52 and the trough portions 54 are distributed on the top surface 46 to obtain a desired slope angle distribution. Of course, the textured top surface 46 of film 28 can have dominant projecting portions and smaller trough portions, can have dominant trough portions and smaller projecting portions, or can have a mix of projecting portions and trough to obtain a desired slope angle distribution.

The slope angle distribution is a distribution of a plurality of slope angles along at least one predetermined trajectory on the diffuser film 28. Further, each slope angle (φ) is calculated using the following equation:

$$SlopeAngle Φ = arctan \vert \frac{Δ h}{Δ w} \vert$$

where:
   Δw represents a predetermined width along the textured surface 46 (e.g., 0.5 micrometers);
   Δh represents a height difference between (i) a lowest position on the textured surface 46 along the width (Δw), and (ii) a highest position on the surface 46 along the width (Δw).

The slope angles for the diffuser film disclosed herein can be calculated from filtered two dimensional surface profile data generated using a Surfcorder ET4000 instrument manufactured by Kosaka Laboratory Limited, Tokyo, Japan. The operational settings of the Surfcorder ET4000 are as follows: Cutoff=0.25 millimeters (mm), Sample Length and Evaluation Length both set at 10 mm. The speed being set at 0.1 millimeters per second (mm/sec) with profile data being obtained at 8,000 equally spaced points.

The slope angles for cylindrical roller surfaces disclosed herein can be calculated from filtered two dimensional surface profile data generated using a Surfcorder SE1700α instrument also manufactured by Kosaka Laboratory Limited. The operational settings of the Kosaka SE1700α are as follows: Evaluation Length 7.2 mm, Cutoff Lc=0.800 mm. The speed being set at 0.500 mm/sec with profile data being obtained at 14,400 points.

The slope angle distribution can be determined along a predetermined reference trajectory or line on the plastic layer. Alternately, a slope angle distribution can be determined on an entire surface of the plastic layer using multiple reference trajectories or lines.

For example, referring to FIGS. 14 and 16, a plurality of slope angles (φ) can be calculated along a predetermined trajectory across textured surface 46, such as a line 60 or a line 62. Alternately, the plurality of slope angles (φ) can be calculated along a line 80 or a line 82. In one or more of the foregoing trajectories, the desired slope angle distribution comprises 20 to 50 percent of slope angles having a value of zero to five degrees, specifically, the desired slope angle distribution comprises between 20 to 50 percent of slope angles having a value of between zero and five degrees.

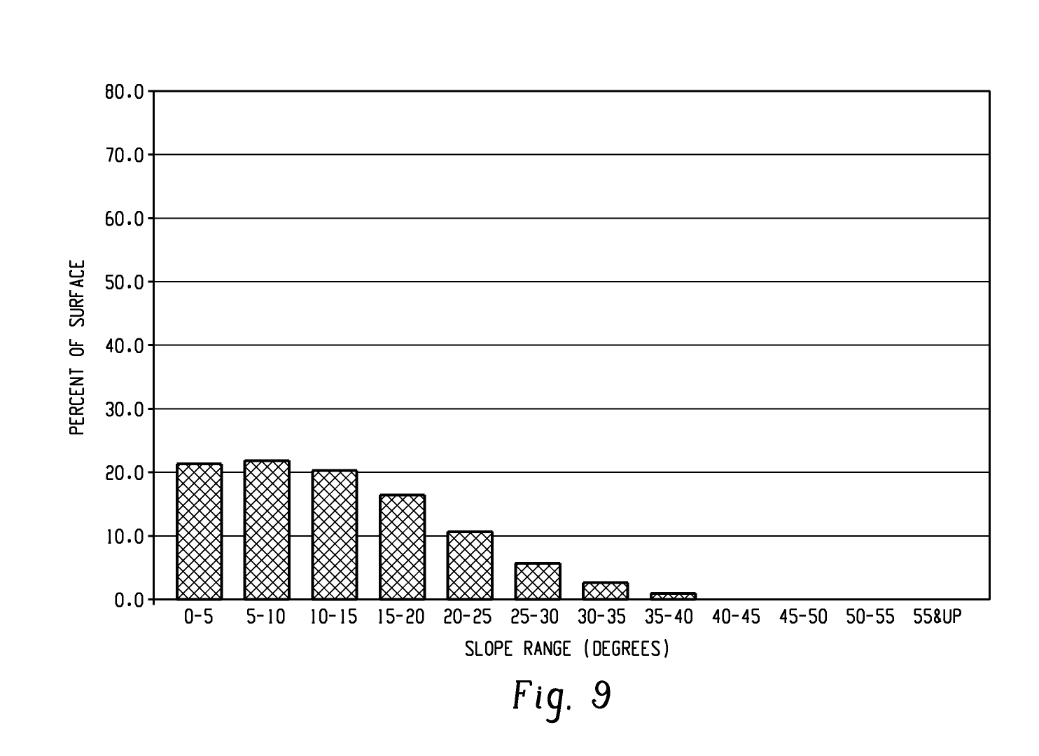

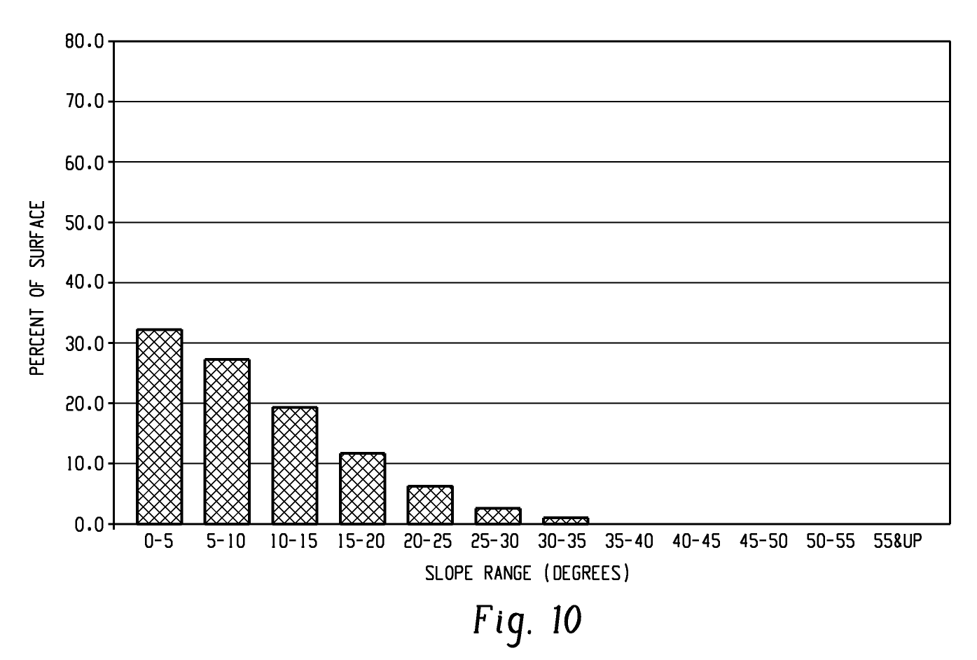

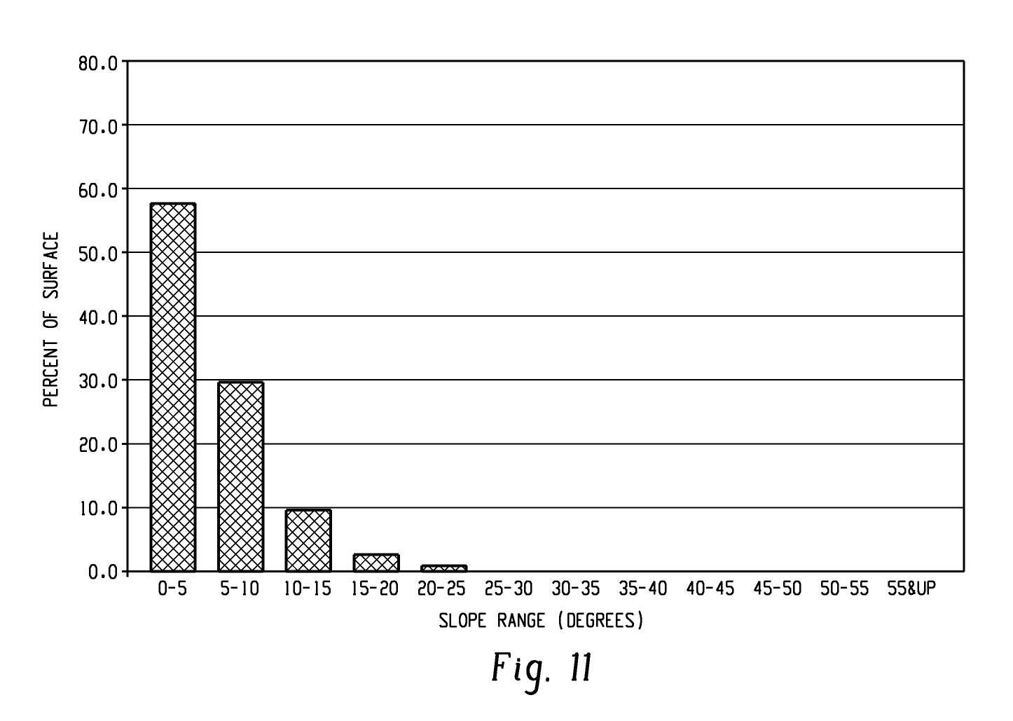

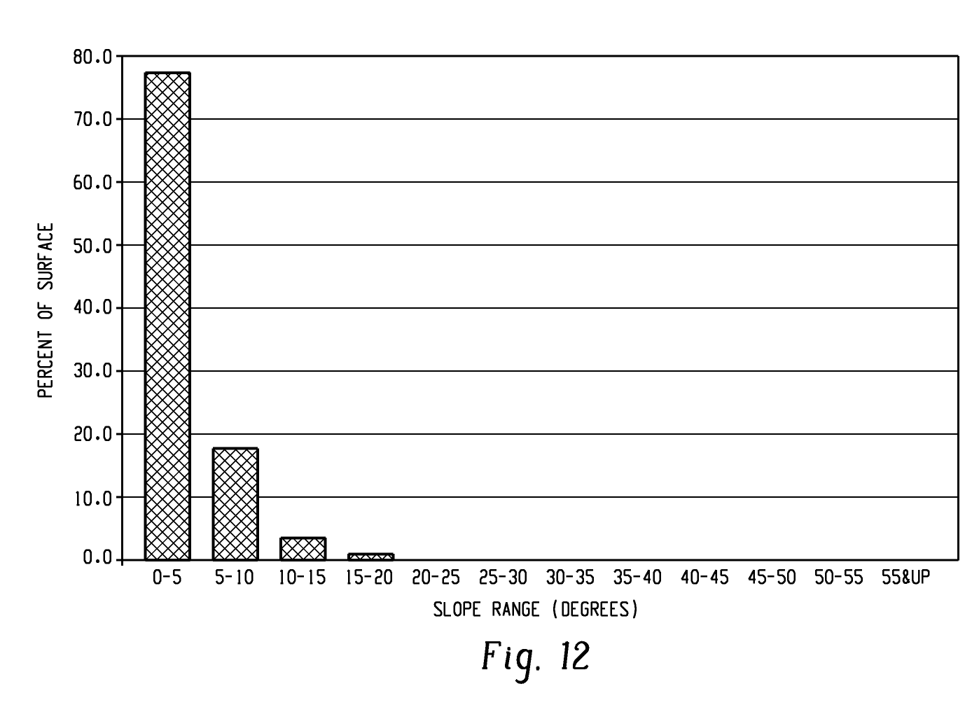

Referring to FIG. 9, a graph illustrating a slope angle distribution of Example 1 of a textured surface 46 on a first side of the film 28 in accordance with an exemplary embodiment is illustrated. As shown, between 20 to 50 percent of slope angles on the textured surface 46 desirably have a value between zero and five degrees. Referring to FIG. 10, a graph illustrating a slope angle distribution of another example, Example 2, of a textured surface 46 on a first side of the film 28 in accordance with an exemplary embodiment is illustrated. As shown, between 20 to 50 percent of slope angles on the textured surface 46 desirably have a value between zero and five degrees. Referring to FIGS. 11 and 12, graphs illustrating slope angle distributions on two film examples (Comparative Examples 1 and 2), where more than 50 percent of slope angles have a value between zero and five degrees. The diffuser films of Comparative Examples 3 and 4 do not have controlled collimation.

Referring to FIG. 8, the film 28 also has a textured surface 48 on a second side of the film 28. The textured surface 48 has a slope angle distribution wherein greater than or equal to or 70 percent of the slope angles on the textured surface 48 have a value between zero and five degrees.

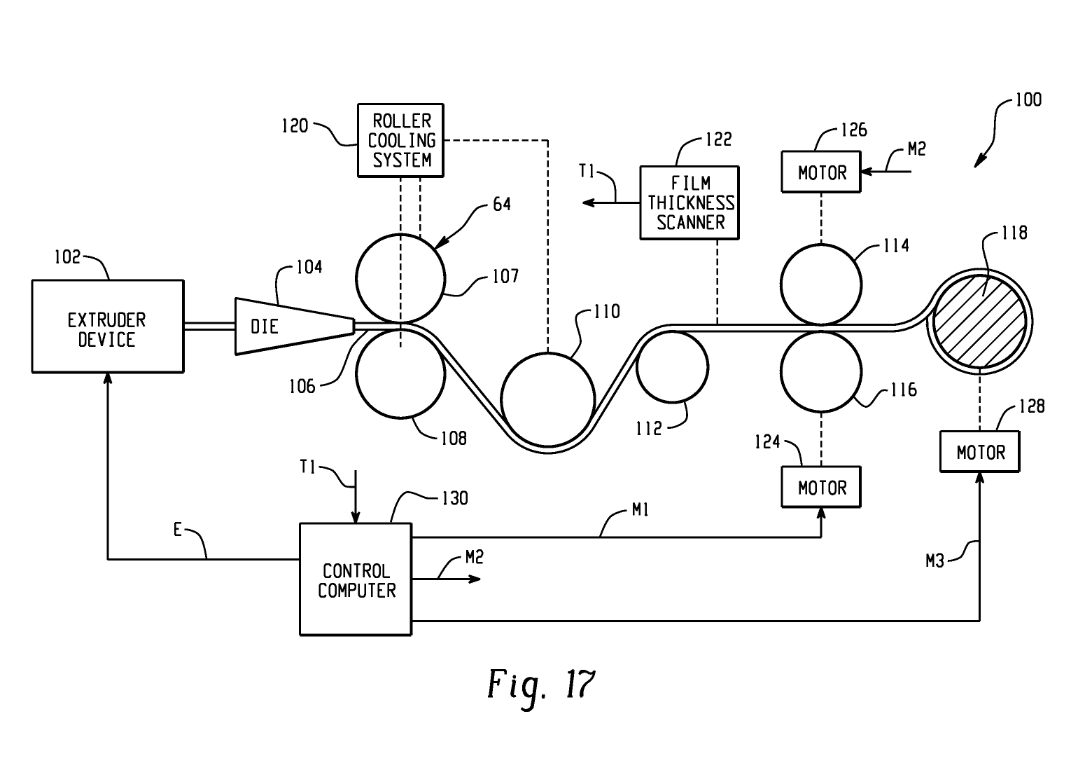

Referring to FIG. 17, an exemplary melt calendaring system 100 for manufacturing a textured plastic layer 106 that can be subsequently cut into a predetermined shape to form diffuser film with controlled light collimation 28 is illustrated. The melt calendaring system 100 includes at least one extruder device 102, a die 104, cylindrical rollers 64, 108, 110, 112, 114, 116, a cylindrical spool 118, a roller cooling system 120, a film thickness scanner 122, motors 124, 126, 128, and a control computer 130.

The extruder device 102 can heat the plastic above a predetermined temperature to induce the plastic to have a liquid state (e.g., molten plastic). For example, the extruder device 102 is operably coupled to the die 104 and to the control computer 130. In response to a control signal (E) from the control computer 130, the extruder device 102 heats plastic therein above a predetermined temperature and urges the plastic through the die 104 to form the plastic layer 106. Of course, multiple extruders can be used to urge multiple streams of plastic through the die 104. The streams can be of different materials and different flow rates to construct a plastic layer 106 having variable internal construction.

The cylindrical rollers 64, 108 are provided to receive the plastic layer 106 therebetween from the die 104 and to form a textured surface on a least one side of the plastic layer 106. The cylindrical rollers 64, 108 can be constructed from metal (e.g., steel) and are operably coupled to the roller cooling system 120. Of course, in an alternate embodiment, the cylindrical rollers 64, 108 may be constructed from other metallic or non-metallic materials. The roller cooling system 120 maintains a temperature of the rollers 64, 108 below a predetermined temperature to solidify the plastic layer 106 as it passes between the rollers 64, 108. The cylindrical roller 64 has a textured surface 107 wherein between 20 to 50 percent of slope angles on the textured surface 107 or along at least one trajectory on the textured surface 107 have a value between zero and five degrees. Thus, when the cylindrical roller 64 contacts a first side of the plastic layer 106, the cylindrical roller 64 forms a textured surface on the plastic layer 106, wherein between 20 to 50 percent of slope angles on the surface 46 of the layer 106 or along at least one trajectory on the textured surface 46 have a value between zero and five degrees.

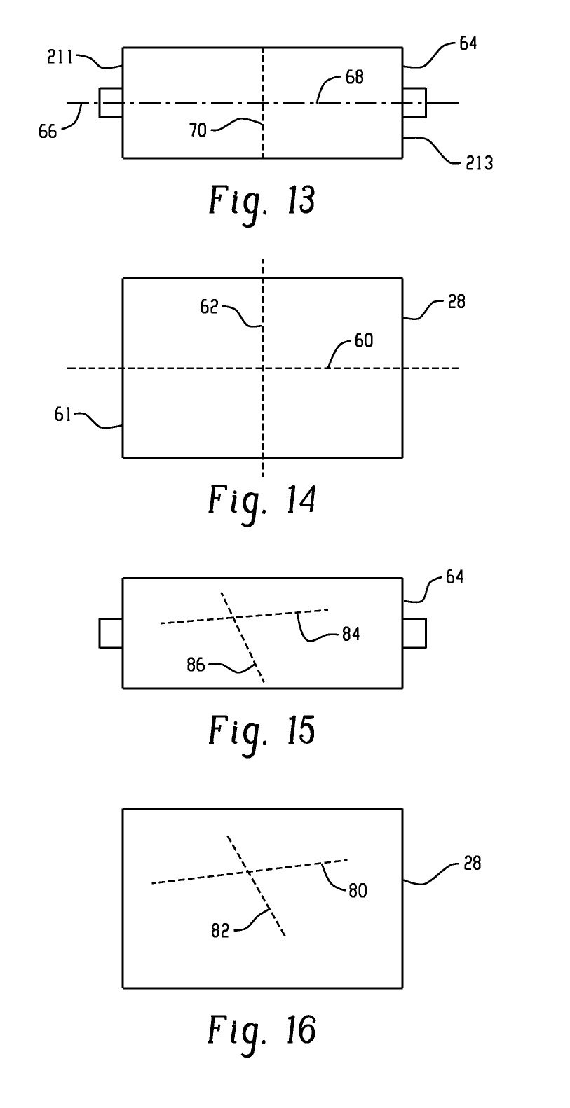

Referring to FIGS. 13 and 15, the slope angles (φ) of the cylindrical roller 64 can be determined along a predetermined trajectory across the outer surface 107, such as a line 68 extending substantially across the roller 64 or a line 70 extending substantially around a periphery of the roller 64. Alternately, the slope angles (φ) of the cylindrical roller 64 can be determined along a line 84 or a line 86.

The cylindrical rollers 64, 108 can create internal stresses in the plastic film as they receive the plastic layer 106 therebetween from the die 104 and to form a textured surface on a least one side of the plastic layer 106. In general, internal stresses negatively impact diffuser film performance. A method was discovered to reduce internal stress levels in the diffuser film with controlled collimation. Internal stresses represented by optical retardation were reduced from approximately 400 to about 500 nm (nanometer), when cylindrical rollers 64 and 108 were both made from rigid materials, to less than 50 nm when at least one of the cylindrical rollers was cladded with a heat-resistant flexible rubber material. Of course, in an alternate embodiment, the cylindrical roller 64, or 108 may be constructed from other metallic or non-metallic materials known to provide required flexible behavior.

The cylindrical rollers 110, 112 are configured to receive the plastic layer 106 after the layer 106 has passed between the rollers 64, 108. The position of the cylindrical roller 110 can be adjusted to vary an amount of surface area of the plastic layer 106 that contacts the cylindrical roller 108. The cylindrical roller 110 is operably coupled to the roller cooling system 120 that maintains the temperature of the roller 110 below a predetermined temperature for solidifying the plastic layer 106. The cylindrical roller 112 receives a portion of the plastic layer 106 downstream of the roller 110 and directs the plastic layer 106 toward the cylindrical rollers 114, 116.

The cylindrical rollers 114, 116 are provided to receive the plastic layer 106 therebetween and to move the plastic layer 106 toward the cylindrical spool 118. The cylindrical rollers 114, 116 are operably coupled to the motors 126, 124, respectively. The control computer 130 generates control signals (M1), (M2) which induce motors 124, 126, respectively, to rotate the rollers 116, 114 in predetermined directions for urging the plastic layer 106 towards the spool 118.

The cylindrical spool 118 is provided to receive the textured plastic layer 106 and to form a roll of plastic layer 106. The cylindrical spool 118 is operably coupled to the motor 128. The control computer 130 generates a control signal (M3) that induces the motor 128 to rotate the spool 118 in predetermined direction for forming a roll of the plastic layer 106.

The film thickness scanner 122 is provided to measure a thickness of the plastic layer 106 prior to the layer 106 being received by the cylindrical rollers 114, 116. The film thickness scanner 122 generates a signal (T1) indicative of the thickness of the plastic layer 106 that is transmitted to the control computer 130.

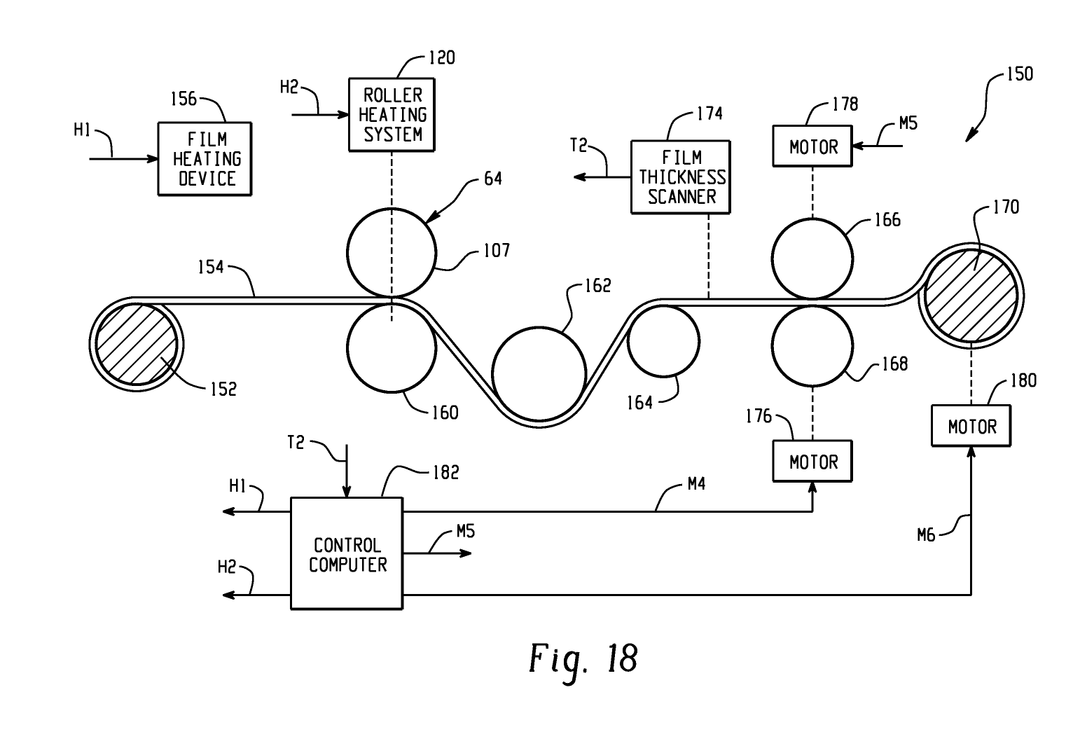

Referring to FIG. 18, an embossing system 150 for manufacturing a plastic layer 154 that can be subsequently cut into a predetermined shape to form the film 28 is illustrated. The embossing system 150 includes a cylindrical spool 152, a film-heating device 156, cylindrical rollers 64, 160, 162, 164, 166, 168, a cylindrical spool 170, a roller heating system 172, a film thickness scanner 174, motors 176, 178, 180, and a control computer 182.

The cylindrical spool 152 is provided to hold the plastic layer 154 thereon. When the cylindrical spool 152 rotates, a portion of the plastic layer 154 is unwound from the spool 152 and moves toward the cylindrical rollers 64, 160. Of course, multiple spools 152 can be used to provide multiple of plastic layers 154 of different materials and gauges. The plastic layers can be combined or laminated into a single layer having variable internal construction as they go through cylindrical rollers 64, and 160.

The film-heating device 156 is provided to heat the plastic layer 154 as it moves from the cylindrical spool 152 towards the cylindrical rollers 64, 160. The control computer 182 generates a signal (H1) that is transmitted to the film-heating device 156 that induces the device 156 to heat the plastic layer 154 above a predetermined temperature.

The cylindrical rollers 64, 160 are provided to receive the plastic layer 154 therebetween from the cylindrical spool 152 and to form a textured surface on at least one side of the plastic layer 154. The cylindrical rollers 64, 160 can be constructed from steel and are operably coupled to the roller heating system 172. Of course, in an alternate embodiment, the cylindrical rollers 64, 160 may be constructed from other metallic or non-metallic materials. The roller heating system 172 maintains a temperature of the rollers 64, 160 above a predetermined temperature to at least partially melt the plastic layer 154 as it passes between the rollers 64, 160. The cylindrical roller 64 has an outer textured surface 107 wherein between 20 to 50 percent of slope angles on the textured surface 107 have a value between zero and five degrees. Thus, when the cylindrical roller 64 contacts a first side of the plastic layer 154, the cylindrical roller 64 forms a textured surface on the plastic layer 154, wherein between 20 to 50 percent of slope angles on the top surface of the layer 154 have a value between zero and five degrees.

The cylindrical rollers 162, 164 are configured to receive the plastic layer 154 after the layer 154 has passed between the rollers 64, 160. The position of the cylindrical roller 162 can be adjusted to vary an amount of surface area of the plastic layer 154 that contacts the cylindrical roller 160. The cylindrical roller 164 receives a portion of the plastic layer 154 downstream of the roller 162 and directs the plastic layer 154 toward the cylindrical rollers 166, 168.

The cylindrical rollers 166, 168 are provided to receive the plastic layer 154 and to move the plastic layer 154 toward the cylindrical spool 170. The cylindrical rollers 166, 168 are operably coupled to the motors 178, 176, respectively. The control computer 182 generates control signals (M4), (M5) which induce motors 176, 178, respectively, to rotate the rollers 168, 166 in predetermined directions for urging the plastic layer 154 towards the spool 170.

The cylindrical spool 170 is provided to receive the plastic layer 154 and to form a roll of plastic layer 154. The cylindrical spool 170 is operably coupled to the motor 180. The control computer 182 generates a control signal (M6) that induces the motor 180 to rotate the spool 170 in predetermined direction for forming a roll of the plastic layer 154.

The film thickness scanner 174 is provided to measure a thickness of the plastic layer 154 prior to the layer 154 being received by the cylindrical rollers 114, 116. The film thickness scanner 174 generates a signal (T2) indicative of the thickness of the plastic layer 154 that is transmitted to the control computer 182.

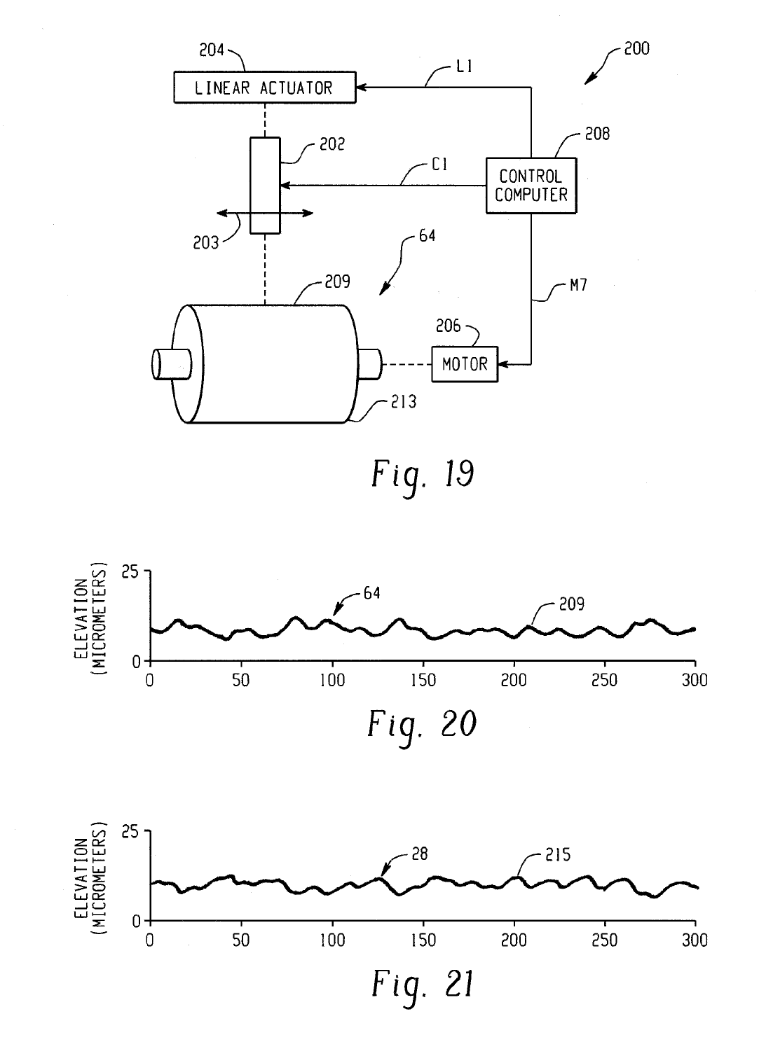

Referring to FIG. 19, a system 200 for forming a textured surface on the cylindrical roller 64 in accordance with an exemplary embodiment is illustrated. The cylindrical roller 64 has a textured surface which can be utilized in the melt calendaring system 100 or the embossing system 150 to form a textured plastic layer used to obtain the film 28. The system 200 includes a laser 202, a linear actuator 204, a motor 206, and a control computer 208.

The laser 202 is provided to emit a pulsating laser beam that contacts an outer surface at a predetermined intensity to remove portions of the outer surface 209 to obtain a textured surface thereon. The laser beam emitted by the laser 202 has a focal diameter at the outer surface 209 of the cylindrical roller 64 of 0.005 to 0.5 millimeters (mm). Further, the laser beam can have an energy level of 0.05 to 1.0 Joules (J) delivered over a time period of 0.1 to 100 microseconds for a predetermined area of the cylindrical roller 64. The laser 202 is operably coupled to the control computer 208 and generates the laser beam in response to a control signal (C1) being received from the control computer 208. The laser 102 can comprise a neodymium (Nd):yttrium, aluminum, garnet (YAG) laser configured to emit a laser beam having a wavelength of 1.06 micrometers. It should be understood, however, that any laser source capable of forming the desired textured surface on a cylindrical roller can be utilized. In an alternate embodiment, the laser 202 can be replaced with an electron beam emission device configured to form the desired textured surface on a cylindrical roller. In still another alternate embodiment, the laser 202 can be replaced with an ion beam emission device configured to form the desired textured surface on a cylindrical roller.

The linear actuator 204 is operably coupled to the laser 202 for moving the laser 202 along an axis 203. The axis 203 is substantially parallel to the outer surface 209 of the cylindrical roller 64. The linear actuator 204 moves the laser 202 relative to the cylindrical roller 64, e.g., at a speed of 0.001 to 0.1 millimeters per second. In an alternate embodiment, linear actuator 204 could be coupled to cylindrical roller 64 to move the roller 64 in an axial direction relative to a stationary laser.

The motor 206 is operably coupled to the cylindrical roller 64 to rotate the roller 64 while the linear actuator 204 is moving the laser 202 along the axis 203 from an end 211 to an end 213 of the roller 64. The control computer 200 generates a signal (M7) that induces the motor 206 to rotate the cylindrical roller 64 at a predetermined speed. In particular, the motor 206 rotates the cylindrical roller 64 such that a linear speed of the outer surface 209 is within a range of 25 to 2,500 millimeters per second (mm/sec).

Referring to FIG. 20, a cross-sectional view of a portion of a textured surface 209 of the cylindrical roller 64 is illustrated. The textured surface 209 was obtained utilizing the energy beam engraving system 200. The textured surface 209 has a slope angle distribution wherein 20 to 50 percent of slope angles (specifically, greater than 20%, more specifically, greater than 20% to 35% of slope angles) on the textured surface 209 have a value of zero to five degrees.

Referring to FIG. 21, a cross-sectional view of a portion of a textured surface 215 of the diffuser film with controlled light collimation 28 cut from a textured plastic layer formed by the cylindrical roller 64 is illustrated. The film 28 has a slope angle distribution wherein between 20 to 50 percent of slope angles (specifically, greater than 20%, more specifically, greater than 20% to 35% of slope angles) on the film 28 have a value between zero and five degrees

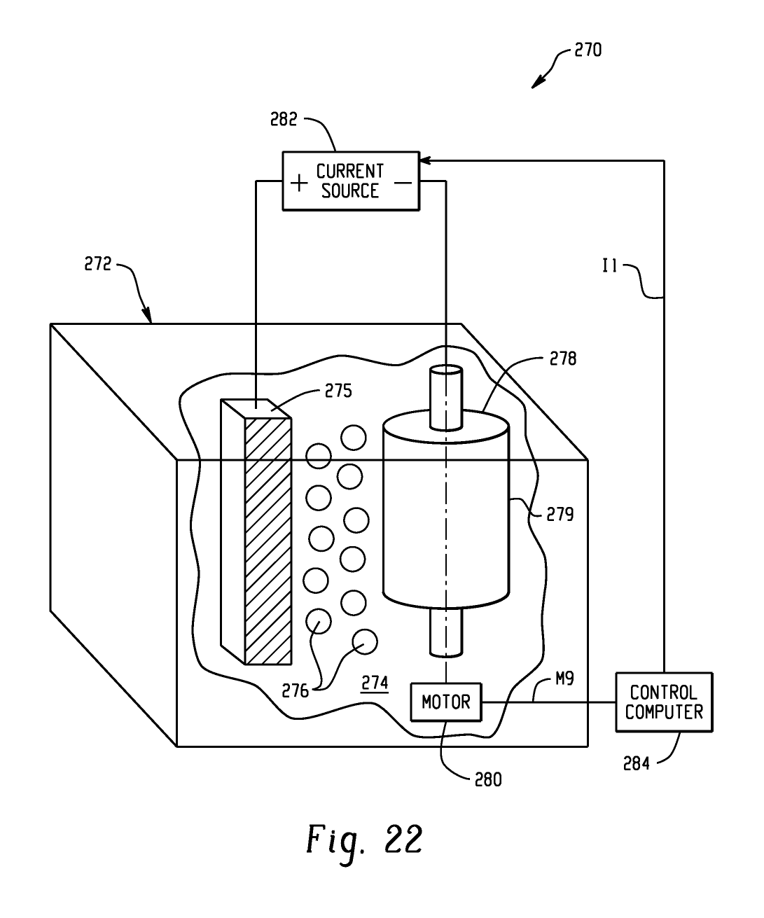

Referring to FIG. 22, a system 270 for forming a textured surface on the cylindrical roller 278 in accordance with another exemplary embodiment is illustrated. The cylindrical roller 278 can be utilized as cylindrical roller 64 either in the melt calendaring system 100 or the embossing system 150 to form a textured plastic layer used to obtain a film having physical characteristics substantially similar to film 28 described above. The system 270 includes a housing 272, a motor 280, a current source 282, and a control computer 284.

The housing 272 defines an interior region 274 for receiving a cylindrical roller 278. The housing 272 holds an electrolyte fluid containing a plurality of metal ions 276. In one embodiment, the plurality of metal ions 276 comprises chromium ions. When a predetermined current density is applied in the electrolyte fluid, the metal ions 276 bond to the outer surface 279 of the cylindrical roller 278 to form a textured surface. The cylindrical roller 278 is rotated within the electrolyte fluid to obtain a textured surface wherein between 20 to 50 percent of slope angles on the textured surface have a value between zero and five degrees.

The motor 280 is operably coupled to the cylindrical roller 278 and is provided to rotate the cylindrical roller 278 at a predetermined rotational speed for a predetermined time period. For example, the motor 280 can rotate the cylindrical roller 278 at a rotational speed of 1 to 10 revolutions per minute (rpm) for a time period of 0.5 to 50 hours. The motor 280 is disposed within the housing 272. In an alternate embodiment, the motor 280 is disposed outside of the housing 272 with a shaft (not shown) extending through the housing 272 coupled to the cylindrical roller 278 for rotating the roller 278. In particular, the control computer 284 generates a signal (M9) that induces the motor 280 to rotate the cylindrical roller 278 at the desired rotational speed.

The current source 282 is provided to apply a predetermined electrical current density through the electrolyte fluid to induce metal ions in the electrolyte fluid to adhere to the outer surface 279 of the cylindrical roller 278. The current source 280 is electrically coupled between a metal bar 275 immersed in the electrolyte fluid and the cylindrical roller 278. The current source 280 is further operably coupled to the control computer 284. The control computer 284 generates a control signal (I1) that induces the current source 282 to generate an electrical current through the electrolyte fluid. In one embodiment, the current source 280 generates a current density in a range of 0.001 to 0.1 amperes per square millimeter (amp/mm²) in the electrolyte fluid to induce the metal ions in the fluid to adhere to the cylindrical roller 278.

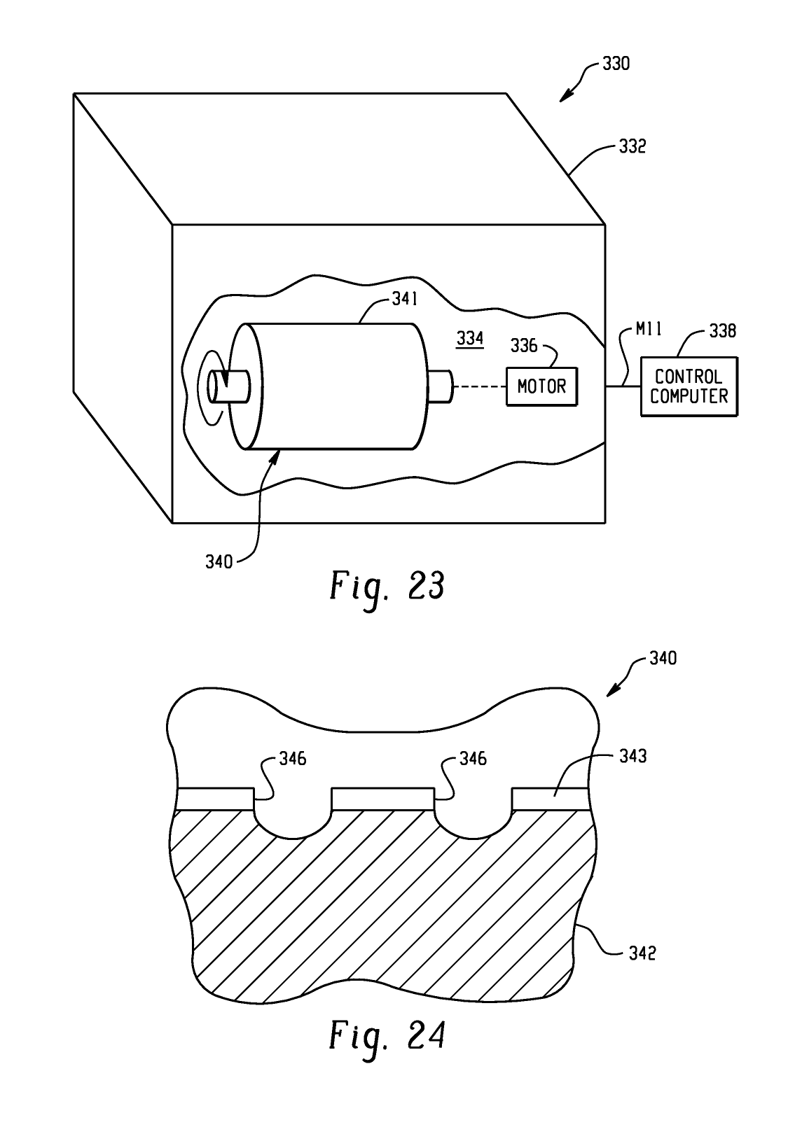

Referring to FIG. 23, a system 330 for forming a textured surface on the cylindrical roller 340 in accordance with another exemplary embodiment is illustrated. The cylindrical roller 340 can be utilized as cylindrical roller 64 either in the melt calendaring system 100 or the embossing system 150 to form a textured plastic layer that can be subsequently cut into a predetermined shape to obtain a film having physical characteristics substantially similar to film 28 described above. The system 330 includes a housing 332, a motor 336, and a control computer 338.

Before explaining the operation of the system 330, a brief explanation of the structure of the cylindrical roller 340 will be provided. Referring to FIG. 24, the cylindrical roller 340 has a substantially cylindrical inner portion 342 coated with a chemically resistant layer 343. The chemically resistant layer 343 comprises a plastic layer. In an alternate embodiment, the chemically resistant layer 343 comprises a wax layer. In yet another alternate embodiment, the chemically resistant layer 343 comprises a photo-resist layer. After the cylindrical roller 340 has been coated by the chemically resistant layer 343, portions of the layer 343 at predetermined locations (e.g., locations 346) are removed. Portions of the layer 343 are removed at predetermined locations using an energy beam, such as a laser. In an alternate embodiment, portions of the layer 343 are removed at the predetermined locations using a tool (not shown) having a hardness greater than the chemically resistant layer 343 but less than a hardness of the cylindrical inner portion 342. In yet another alternate embodiment, the chemically resistant layer 343 is removed at the predetermined locations using a lithographic process known to those skilled in the art.

The housing 332 defines an interior region 334 for receiving a cylindrical roller 340. The housing 332 holds an etching solution for removing exposed portions of the inner portion 342 of the cylindrical roller 340. The etching solution includes nitric acid wherein 5 to 25 percent of a mass of the etching solution is nitric acid. In an alternate embodiment, the etching solution includes hydrochloric acid wherein 5 to 25 percent of a mass of the etching solution is hydrochloric acid. When the cylindrical roller 340 is rotated within the etching fluid, the etching fluid removes portions of the cylindrical roller 340 proximate the locations 346 to form a textured surface wherein between 20 to 50 percent of slope angles on the textured surface have a value between zero and five degrees.

The motor 336 is operably coupled to the cylindrical roller 340 and is provided to rotate the cylindrical roller 340 at a predetermined rotational speed. The motor 336 is disposed within the housing 332. In an alternate embodiment, the motor 336 is disposed outside of the housing 332 with a shaft (not shown) extending through the housing 332 coupled to the cylindrical roller 340 for rotating the roller 340. The control computer 338 generates a signal (M11) that induces the motor 336 to rotate the cylindrical roller 341 at a predetermined rotational speed. In particular, the motor 336 can rotate the cylindrical roller 341 at a rotational speed in a range of 1 to 50 revolutions per minute (rpm).

Additional systems for forming a textured surface on the cylindrical roller 64 in accordance for use in manufacturing the diffuser film with controlled light collimation can be adapted from those provided in U.S. Pat. No. 7,889,427 (Bastawros, et al.).

### EXAMPLES

### Example 1

A unitary polycarbonate diffuser film with controlled light collimation was made using the melt calendering system 100 shown in FIG. 17, wherein the surface of cylindrical roller 64 was prepared using the system 200 shown in FIG. 19. The resulting film has a first textured surface comprising a plurality of projecting portions and a plurality of trough portions, wherein each projecting portion extends outwardly from at least one adjacent trough portion as illustrated in FIG. 20. The widths of the projecting portions are 20 to 45 micrometers and the height of the projecting portion is 1 to 7 micrometers. The aspect ratio determined as height divided by width of a projecting portion is 0.05 to 0.15. The percentage of the slope angle between 0 and 5 degrees for the first textured surface is 21.5%, FIG. 9. This value is the averages of six readings on the first textured surface; three readings were taken along three lines that are parallel to a first axis and three readings were taken along three lines that are parallel to a second axis. The first axis was selected parallel to an edge of the film, and the second axis was selected perpendicular to the first axis. The lines along which the measurements were taken were spaced apart by about 2 to 3 millimeters. Slope distributions were determined according to the procedure previously described. The second surface of the diffuser film is sufficiently flat wherein the percentage of the slope angle between 0 and 5 degrees for the second surface is 80%.

### Example 2

A unitary polycarbonate diffuser film with controlled light collimation was made using the melt calendering system 100 shown in FIG. 17, wherein the surface of cylindrical roller 64 was prepared using the system 270 shown in FIG. 22. The resulting film has a first textured surface comprising a plurality of randomly sized trough portions that are dominating the surface, wherein the width of an individual trough is 20 to 100 micrometers, and the depth is 1 to 20 micrometers. The aspect ratio determined as depth divided by width of a trough portion is 0.05 to 0.2. The percentage of the slope angle between 0 and 5 degrees for the first textured surface is 32%, FIG. 10. The second surface of the diffuser film is sufficiently flat wherein the percentage of the slope angle between 0 and 5 degrees for the second surface is 72%.

### Comparative Example 1

A unitary polycarbonate non-collimating diffuser film with the first textured surface comprising a plurality of random distributed projecting portions and a plurality of trough portions. The percentage of the slope angle between 0 and 5 degrees for the first textured surface is 57%, FIG. 10, and the percentage of the slope angle between 0 and 5 degrees for the second surface is 62%.

Comparative Example 2 is similar to Comparative Example 1 except that the percentage of the slope angle between 0 and 5 degrees for the first textured surface is 77%, FIG. 11, and the percentage of the slope angle between 0 and 5 degrees for the second surface is 85%.

Comparative Example 3 is a unitary polycarbonate high-collimation diffuser film (e.g., FIG. 1) with the first textured surface comprising a plurality of projecting portions and a plurality of trough portions, wherein each projecting portion extends outwardly from at least one adjacent trough portion. The percentage of the slope angle between 0 and 5 degrees for the first textured surface is 8.9% and the percentage of the slope angle between 0 and 5 degrees for the second surface is 80%.

The haze of each individual diffuser film as described in the above examples and the comparative examples was measured according to the method in JIS K7105. On-axis luminance was measured in two configurations:
I. A single diffuser film (e.g., film 28) placed by-itself on the light guide of FIG. 5, and
II. A complete film stack configuration as shown in FIG. 5, where the diffuser film with controlled light collimation (e.g., film 28) is placed directly above the light guide.
   Luminance results for back light configuration of FIG. 5 are summarized in Table 1.

TABLE 1

| | | | Compar- | Compar- | Compar- |
|---|---|---|---|---|---|
| | Exam- | Exam- | ative | ative | ative |
| | ple 1 | ple 2 | Example 1 | Example 2 | Example 3 |
| % slope angle of | 21.5 | 32.2 | 57.8 | 77.5 | 8.9 |
| first surface of | | | | | |
| 0° to 5° | | | | | |
| % slope angle of | 80 | 72 | 62 | 85 | 80 |
| second surface of | | | | | |
| 0° to 5° | | | | | |
| Luminance | 100 | 102 | 91 | 87 | 139 |
| Configuration I | | | | | |
| (normalized unit | | | | | |
| (%)) | | | | | |
| Luminance | 100 | 95 | 95 | 95 | 97 |
| Configuration II | | | | | |
| (normalized | | | | | |
| (units) (5)) | | | | | |
| Haze (%) | 97.0 | 95.2 | 78.2 | 44.5 | 99.8 |

Compared to the three comparative examples, the diffuser film with controlled light collimation of Examples 1 has an intermediate level of light collimation capability by itself (as shown by the on-axis luminance of the single diffuser film) but provides the highest on-axis luminance when used as the bottom diffuser (film 28) in the backlight configuration of FIG. 5. This diffuser also provides a desirable high haze of 97%. The combination of both high haze and controlled light collimation makes the diffuser film in Example 1 the most suitable for the backlight application in FIG. 5.

The diffuser film with controlled light collimation of Examples 2 also has an intermediate level of light collimation capability by itself. When compared to Comparative Examples 1 and 2, this film provides higher haze, i.e. hiding power, while maintaining comparable luminance in the configuration of FIG. 5. Achieving high haze without penalizing luminance makes this diffuser film suitable for backlight application similar to that of FIG. 5.

In an alternative film configuration shown in FIG. 4 the diffuser film with controlled light collimation (28) is now used as a top diffuser. In this configuration, diffusion of transmitted light such that the lamp pattern is not discernible, i.e., hiding power, is an important performance criterion. Table 2 sets the results for the optical performance in the example film configuration of FIG. 4.

TABLE 2

| | | Comparative |
|---|---|---|
| | Example 1 | Example 3 |
| Percentage of slope angle between 0 and 5 | 21.5 | 8.9 |
| degree for the first surface | | |
| Percentage of slope angle between 0 and 5 | 80 | 80 |
| degree for the second surface | | |
| on-axis brightness of the film stack | 94 | 87.7 |
| configuration in FIG. 4 (arbitrary unit) | | |
| Haze (%) | 97 | 99.8 |
| Hiding Power represented by Visual Grade | 6 | 7 |
| Index | | |

When compared to comparative example 3, the diffuser film of Examples 1 provides the highest on-axis luminance when used as the top diffuser (film 28) in the backlight configuration of FIG. 4. With its desirable high haze of 97%, this diffuser reaches 6 on the Visual Grade Index. This Index, commonly used in the display industry refers to films ability to hide the lamp pattern underneath the film stack (hiding power); higher values are better. Values greater than 5 for this Index indicate good hiding power. The combination of both good hiding power and controlled light collimation makes the diffuser film in Example 1 the most suitable for the backlight application in FIG. 4.

The diffuser film with controlled light collimation and the method for manufacturing the film represents a substantial advantage over other systems and methods. In particular, the system and method have a technical effect of providing a plastic layer having a textured surface capable of diffusing light that can readily manufactured without having any additional material being added to the plastic layer such as polystyrene beads in an acrylate solution.

A diffuser film with controlled light collimation can comprise: a plastic layer having a first side and a second side opposite the first side and a first peripheral edge, the first side having a first textured surface, wherein 20 to 50 percent of slope angles on the first textured surface proximate a first axis have a value of zero to five degrees.

A diffuser film with controlled light collimation can comprise: a unitary layer wherein greater than or equal to 80 percent of a total mass of the unitary layer comprises a polycarbonate compound, the unitary layer having a first side and a second side opposite the first side and a first peripheral edge, the first side having a first textured surface, wherein 20 to 50 percent of slope angles on the first textured surface proximate a first axis have a value of zero to five degrees, the first axis being substantially parallel to the first peripheral edge, wherein the plastic layer controls the collimation of light propagating therethrough.

In the various embodiments, (i) the first textured surface can comprise a plurality of projecting portions and a plurality of trough portions, wherein each projecting portion extends outwardly from an adjacent trough portion; and/or (ii) an average height of the plurality of projecting portions can be 5 to 25 percent of an average width of the plurality of projecting portions; and/or (iii) an average width of the plurality of projecting portions can be 0.5 to 100 micrometers; and/or (iv) the plastic layer can control collimation of light propagating through the plastic layer from the second side to the first side; and/or (v) the plastic layer can control collimation of light passing therethrough toward an axis perpendicular to the plastic layer; and/or (vi) the second side can comprise a second textured surface, wherein greater than or equal to 70 percent of slope angles on the second textured surface have a value of zero to five degrees; and/or (vii) the plastic layer can contain an optical brightener in a range of 0.001-1.0 percent of a total mass of the plastic layer; and/or (viii) the plastic layer can further comprise an antistatic compound therein; and/or (ix) the antistatic compound can comprise a fluorinated phosphonium sulfonate; and/or (x) the plastic layer can further comprise a UV absorber compound in an amount of 0.01 to 1.0 percent of a total mass of the plastic layer; and/or (xi) the plastic layer can have a thickness of 0.025 millimeters to 10 millimeters; and/or (xii) the thickness can be 0.025 millimeters to 2 millimeters; and/or (xiii) greater than or equal to 80 percent of a total mass of the plastic layer can comprise a polycarbonate compound; and/or (xiv) the plastic layer can contain an optical brightener in a range of 0.001-1.0 percent of a total mass of the plastic layer; and/or (xv) an internal stress in the plastic layer expressed in terms of optical retardation can be less than or equal to 50 nanometers; and/or (xvi) the plastic layer can have a haze value greater than or equal to 80%; and/or (xvii) 20 to 50 percent of slope angles on the first textured surface proximate a second axis can have a value of zero to five degrees, and wherein the second axis is substantially perpendicular to the first axis.

A back lighted device can comprise a light source and any of the above diffuser films. Optionally, a light guide can be disposed proximate the light source for receiving light from the light source. Optionally the device can further comprise a light directing film disposed proximate the first textured surface.

While the invention is described with reference to exemplary embodiments, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiments disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

What is claimed is:

1. A diffuser film with controlled light collimation, comprising:
a plastic layer having a first side and a second side opposite the first side and a first peripheral edge, the first side having a first textured surface comprising projecting portions and/or trough portions, wherein 20 to 50 percent of slope angles on the first textured surface proximate a first axis have a value of greater than zero to five degrees; wherein the projecting portions and/or the trough portions have an average width of 20 μm to 100 μm.

2. The diffuser film of claim 1, wherein the first textured surface comprises a plurality of projecting portions and a plurality of trough portions, wherein each projecting portion extends outwardly from an adjacent trough portion.

3. The diffuser film of claim 2, wherein an average height of the plurality of projecting portions is 5 to 25 percent of an average width of the plurality of projecting portions.

4. The diffuser film of claim 2, wherein the average width of the plurality of projecting portions is 20 to 45 micrometers.

5. The diffuser film of claim 1, wherein the plastic layer controls collimation of light propagating through the plastic layer from the second side to the first side.

6. The diffuser film of claim 1, wherein the plastic layer controls collimation of light passing therethrough toward an axis perpendicular to a surface of the plastic layer.

7. The diffuser film of claim 1, wherein the second side comprises a second textured surface, wherein greater than or equal to 70 percent of slope angles on the second textured surface have a value of zero to five degrees.

8. The diffuser film of claim 1, wherein the plastic layer contains an optical brightener in a range of 0.001-1.0 percent of a total mass of the plastic layer.

9. (canceled)

10. The diffuser film of claim 1, wherein the plastic layer comprises a fluorinated phosphonium sulfonate.

11. The diffuser film of claim 10, wherein the plastic layer further comprises a UV absorber compound in an amount of 0.01 to 1.0 percent of a total mass of the plastic layer.

12. The diffuser film of claim 1, wherein the plastic layer has a thickness of 0.025 millimeters to 10 millimeters.

13. The diffuser film of claim 12, wherein the thickness is 0.025 millimeters to 2 millimeters.

14. The diffuser film of claim 1, wherein greater than or equal to 80 percent of a total mass of the plastic layer comprises a polycarbonate compound.

15. The diffuser film of claim 1, wherein the plastic layer contains an optical brightener in a range of 0.001-1.0 percent of a total mass of the plastic layer.

16. The diffuser film of claim 1, wherein an internal stress in the plastic layer expressed in terms of optical retardation is less than or equal to 50 nanometers.

17. The diffuser film of claim 1, wherein the plastic layer has haze value greater than or equal to 80%.

18. The diffuser film of claim 1, wherein 20 to 50 percent of slope angles on the first textured surface proximate a second axis have a value of zero to five degrees, and wherein the second axis is substantially perpendicular to the first axis.

19. A diffuser film with controlled light collimation comprising:
a unitary layer wherein greater than or equal to 80 percent of a total mass of the unitary layer comprises a polycarbonate compound, the unitary layer having a first side and a second side opposite the first side and a first peripheral edge, the first side having a first textured surface comprising projecting portions and/or trough portions, wherein 20 to 50 percent of slope angles on the first textured surface proximate a first axis have a value of greater than zero to five degrees, the first axis being substantially parallel to the first peripheral edge, wherein the plastic layer controls collimation of light propagating therethrough; and wherein the projecting portions and/or the trough portions have an average width of 20 μm to 100 μm.

20. A back lighted device, comprising:
a light source;
a light guide disposed proximate the light source for receiving light from the light source; and
user film of claim 1.

21. The back lighted device of claim 20, further comprising a light directing film disposed proximate the first textured surface.

22. A method of controlling collimation in a diffusing film, comprising:
determining a desired degree of collimation for the diffusing film;
forming a plastic layer having a first side and a second side opposite the first side and a first peripheral edge, and
texturing the first side to form a first textured surface comprising projecting portions and/or trough portions, wherein 20 to 50 percent of slope angles on the first textured surface proximate a first axis have a value of greater than zero to five degrees, wherein the projecting portions and/or the trough portions have an average width of 20 μm to 100 μm.

23. The diffuser film of claim 1, wherein the plastic layer is configured to attain controlled light collimation using the textured surface and without using additional material.
